(19) United States
(12) Patent Application Publication
(10) Pub. No.: US 2008/0285747 A1
(43) Pub. Date: Nov. 20, 2008

(54) ENCRYPTION-BASED SECURITY PROTECTION METHOD FOR PROCESSOR AND APPARATUS THEREOF

(75) Inventors: Jin-mok KIM, Yongin-si (KR); Jae-min Lee, Suwon-si (KR); Hyung-jick Lee, Seongnam-si (KR); Yang-lim Choi, Seongnam-si (KR); Dae-yong Sim, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: Samsung Electronics Co., Ltd., Suwon-si (KR)

(21) Appl. No.: 11/943,703

(22) Filed: Nov. 21, 2007

(30) Foreign Application Priority Data
May 14, 2007 (KR) 10-2007-0046664

(51) Int. Cl. H04L 9/00

(52) U.S. Cl. 380/44

(57) ABSTRACT

An encryption-based security protection method and apparatus are provided. The method includes generating a random key pattern table in order to allocate a plurality of random key patterns of original data to be transmitted; generating an address pattern table in order to allocate a plurality of address patterns of addresses in which the original data is stored; and generating a mapping table in order to map the plurality of random key patterns and the plurality of address patterns. The apparatus includes an address pattern table generation unit; a random key pattern table generation unit; a mapping table generation unit; and an internal memory unit which stores the address pattern table, the random key pattern table, and the mapping table.

### CROSS-REFERENCE TO RELATED PATENT APPLICATION

This application claims priority from Korean Patent Application No. 10-2007-0046664, filed on May 14, 2007, in the Korean Intellectual Property Office, the disclosure of which is incorporated herein in its entirety by reference.

### BACKGROUND OF THE INVENTION

1. Field of the Invention

Methods and apparatuses consistent with the present invention relate to an encryption-based security protection method for a processor and an apparatus thereof, and more particularly, to an encryption-based security protection method for a processor which securely protects data that is to be transmitted from a processor, such as a digital rights management (DRM) card or a security chip, to external memory, and an apparatus thereof.

2. Description of the Related Art

Recently, illegal copying of music or audio visual contents is often performed and people may obtain illegally copied contents easily. Accordingly, digital rights management (DRM) has been proposed to address this problem.

In DRM technology, contents are protected by being encrypting. Due to the encrypting of the contents, unauthorized people are not allowed to access the contents without permission. In this case, decrypted contents and secret information such as a key have to be prevented from being exposed to an external memory or a system bus.

FIG. 1 is a diagram illustrating a related art DRM card 100 and an external memory 110, which are connected to each other by a system bus.

Referring to FIG. 1, the DRM card 100 includes an internal central processing unit (CPU) 102, an internal memory 104, and a bus interface 106.

In general, the DRM card 100 is a storage device to which the DRM technology is applied.

The internal CPU 102 controls general operations of the DRM card 100. The internal memory 104 stores contents and data required for the operations of the DRM card 100. However, if storage space of the internal memory 104 increases, the cost and the size of the DRM card 100 also increase. Therefore, in general, most data, except for minimum data required for the operations of the DRM card 100, is stored in the bus interface 106 or is stored in the external memory 110 through the system bus. The bus interface 106 connects the DRM card 100 to the external memory device 110 or other devices.

The DRM card 100 may not externally expose the internal data and any device connected to the system bus may not access the internal memory 104 of the DRM card 100. Accordingly, in general, the internal data of the DRM card 100 is safe from being attacked by hackers.

However, due to characteristics of the DRM card 100 which shares the external memory device 110 with other devices, if unencrypted secret information or contents are transmitted from the DRM card 100 to the external memory device 110, the hackers may attack the unencrypted secret information or contents which are exposed by the external memory device 110 or the system bus.

Furthermore, the DRM card 100 has to store a random key in order to decrypt data encrypted by the random key and thus a large storage space is required.

### SUMMARY OF THE INVENTION

The present invention provides an encryption-based security protection method for a processor which securely protects data that is to be transmitted from a processor, such as a digital rights management (DRM) card, to a system bus, from being attacked by hackers, and an apparatus thereof.

The present invention also provides an encryption-based security protection method for a processor which may flexibly control the size of storage space of an internal memory of the processor, and an apparatus thereof.

According to an aspect of the present invention, there is provided an encryption-based security protection method for a processor, the method including generating a random key pattern table in order to allocate random key patterns of original data to be transmitted to an external memory device; generating an address pattern table in order to allocate address patterns of addresses to which the original data is stored; and generating a mapping table in order to map the random key patterns and the address patterns.

The method may further include determining sizes of the random key pattern table and the address pattern table.

The method may further include firstly encrypting the original data by using an address of the original data to be transmitted to the external memory device as a key to generate first-encrypted data.

The method may further include searching the address pattern table for an address pattern of the first-encrypted data to be transmitted to the external device; searching the mapping table and the random key pattern table for a random key pattern mapped to the address pattern; generating a random key of the first-encrypted data in accordance with the random key pattern; and secondly encrypting the first-encrypted data by using the random key to generate second-encrypted data.

The method may further include searching the address pattern table for an address pattern of the original data to be transmitted to the external device; searching the mapping table and the random key pattern table for a random key pattern mapped to the address pattern; generating a random key of the original data in accordance with the random key pattern; and thirdly encrypting the original data by using the random key to generate third-encrypted data.

The random key pattern table and the address pattern table may be generated so as to have the sizes determined by the determining of the sizes of the random key pattern table and the address pattern table.

The method may be newly performed whenever a system is booted.

The address patterns of the addresses to which the original data is stored may be randomly allocated.

The random key patterns may be generated so that bits of a random key pattern have different bit positions or a different number of bits compared to bits of another random key pattern.

In the mapping table, the random key patterns and the address patterns may randomly mapped.

The generating of the address pattern table may include allocating the address patterns to remainders obtained by dividing the addresses by the size of the address pattern table.

The secondly encrypting may be performed by an exclusive OR (XOR) operation.

The thirdly encrypting may be performed by an XOR operation.

The method may further include transmitting the second-encrypted data to the external memory device.

The method may further include transmitting the third-encrypted data to the external memory device.

The method may further include decrypting encrypted data received from the external memory device by using the random key.

According to another aspect of the present invention, there is provided an encryption-based security protection apparatus for a processor, the apparatus including an address pattern table generation unit which generates an address pattern table in order to allocate address patterns of addresses to which original data to be transmitted to an external memory device is stored; a random key pattern table generation unit which generates a random key pattern table in order to allocate random key patterns of the original data; a mapping table generation unit which generates a mapping table in order to map the address patterns and the random key patterns; and an internal memory unit which stores the address pattern table, the random key pattern table, and the mapping table.

According to another aspect of the present invention, there is provided a computer readable recording medium having recorded thereon a computer program for executing an encryption-based security protection method for a processor, the method including generating a random key pattern table in order to allocate random key patterns of original data to be transmitted to an external memory device; generating an address pattern table in order to allocate address patterns of addresses to which the original data is stored; and generating a mapping table in order to map the random key patterns and the address patterns.

### BRIEF DESCRIPTION OF THE DRAWINGS

The above and other aspects of the present invention will become more apparent by describing in detail exemplary embodiments thereof with reference to the attached drawings in which:

FIG. 1 is a diagram illustrating a related art digital rights management (DRM) card and an external memory device connected to each other by a system bus;

FIG. 2 is a flowchart of an encryption-based security protection method, according to an exemplary embodiment of the present invention;

FIG. 3 is a diagram of an example of a random key pattern table according to the method of FIG. 2, according to an exemplary embodiment of the present invention;

FIG. 4 is a diagram of an example of an address pattern table according to the method of FIG. 2, according to an exemplary embodiment of the present invention;

FIG. 5 is a diagram of an example of a mapping table according to the method of FIG. 2, according to an exemplary embodiment of the present invention;

FIG. 6 is a flowchart of an encryption-based security protection method, according to another exemplary embodiment of the present invention;

FIG. 7 is a flowchart of an encryption-based security protection method, according to another exemplary embodiment of the present invention;

FIG. 8 is a diagram of an example of encrypting original data by using an address of the original data as a key, according to an exemplary embodiment of the present invention;

FIG. 9 is a diagram of an example of encrypting intermediate data by using a random key, according to an exemplary embodiment of the present invention;

FIG. 10 is a diagram of an encryption-based security protection apparatus, according to an exemplary embodiment of the present invention; and

FIG. 11 is a diagram of an encryption-based security protection apparatus, according to another exemplary embodiment of the present invention.

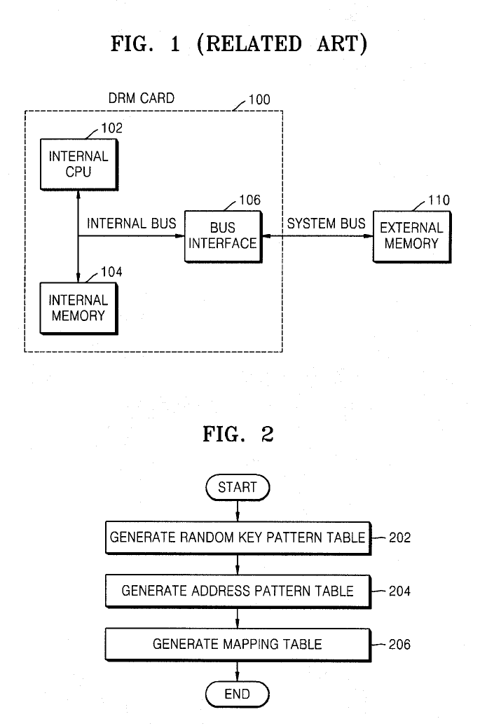

### DETAILED DESCRIPTION OF THE INVENTION

Hereinafter, the present invention will be described in detail by explaining exemplary embodiments of the invention with reference to the attached drawings.

FIG. 2 is a flowchart of an encryption-based security protection method, according to an exemplary embodiment of the present invention.

Referring to FIG. 2, in operation 202, a random key pattern table is generated in order to allocate random key patterns of original data. The random key pattern indicates which bit or bits of the original data are to be transmitted from a processor (such as a digital rights management (DRM) card or a security chip) to an external memory device. The random key pattern is used as a random key. The random key pattern does not always have to be certain bit positions or the number of the certain bits. Accordingly, each random key pattern may be randomly generated so as to select a bit or bits having different bit positions or a different number of bits from another random key pattern.

The random key pattern table denotes a set of a number of the random key patterns. The number of the random key patterns may be predetermined. The number of the random key patterns of the random key pattern table (that is, the size of the random key pattern table) does not always have to be a certain number and may be flexibly determined, for example, in accordance with a storage space of an internal memory unit of a processor.

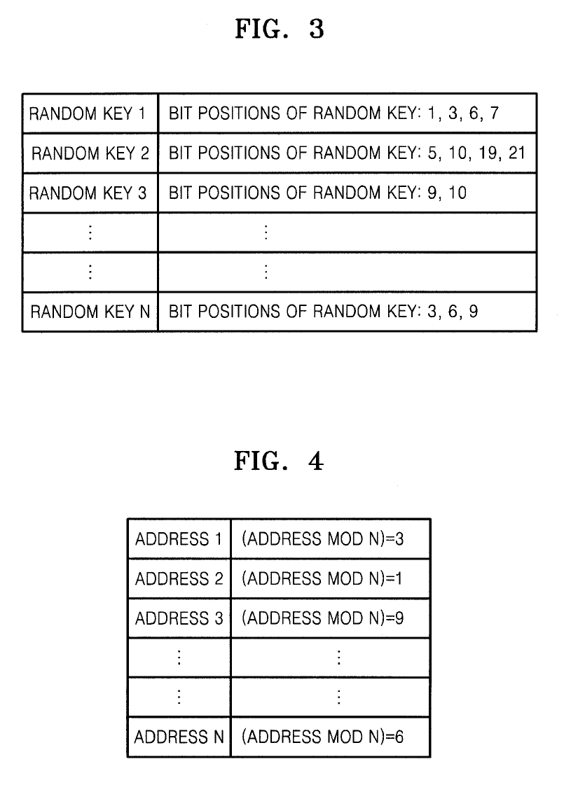

FIG. 3 is a diagram of an example of the random key pattern table according to the method of FIG. 2, according to an exemplary embodiment of the present invention.

Referring to FIG. 3, a random key pattern table having a number of random key patterns, for example, N random key patterns, is illustrated. For example, a random key pattern of Random Key 2 is the 5^{th}, 10^{th}, 19^{th}, and 21^{st} bits of the original data, and a random key pattern of Random Key 3 is the 9^{th} and 10^{th} bits of the original data. The number of bits of the random key pattern of Random Key 2, which is four, is different from the number of bits of the random key pattern of Random Key 3, which is two. Accordingly, the random key patterns may have different bit positions of a random key and different numbers of bits compared to each other.

However, as shown in FIG. 3, the numbers of bits of the random key patterns do not have to be different. For example, Random Key 1 and Random Key 2 have the same number of bits, which is four. Although the numbers of bits are the same, it does not matter if the bit positions of the random key are different.

In order to prevent original data from being attacked by hackers, the random key pattern table may be updated whenever a system including an apparatus according to an exemplary embodiment of the present invention is booted. When or how often to update the random key pattern table may be properly determined, for example, in consideration of a necessity of data protection and a reduction of system load.

Also, the bit positions and the numbers of bits of each random key pattern may be differently determined from another random key pattern.

Referring back to FIG. 2, in operation 204, an address pattern table is generated in order to allocate address patterns of addresses to which the original data is stored. The address patterns are several different patterns of addresses of the external memory device in which the original data transmitted from the processor is stored.

The address pattern table denotes a set of the different address patterns. The number of the address patterns of the address pattern table (that is, the size of the address pattern table) may be flexibly determined, for example, in accordance with the storage space of the internal memory unit of the processor. However, the size of the address pattern table may also be determined to be the same as the size of the random key pattern table determined in operation 202.

FIG. 4 is a diagram of an example of an address pattern table according to the method of FIG. 2, according to an exemplary embodiment of the present invention.

Referring to FIG. 4, an address pattern table having N address patterns is illustrated. For example, Address 1 is an address satisfying (address mod N)=3, and Address 2 is an address satisfying (address mod N)=1. Here, (address mod N) is a remainder obtained by dividing an address by N, that is, the size of the address pattern table.

A value (address mod N) of an address pattern may be different from a value (address mod N) of another address pattern. For example, both Address 1 and Address 2 may not satisfy (address mod N)=5.

As such, addresses of original data stored in an external memory device are divided into the N address patterns. However, the dividing of the address patterns is not limited to the above-described method. A variety of methods may be flexibly used.

In order to prevent original data from being attacked by hackers, the address pattern table may be updated whenever a system including an apparatus according to an exemplary embodiment of the present invention is booted. An update time of the address pattern table may be properly determined in consideration of a necessity of data protection and a reduction of system load.

Also, the address patterns of the addresses to which the original data is stored may be randomly allocated. For example, Address 1 does not always have to be the address satisfying (address mod N)=3 as shown in FIG. 4, and may be an address satisfying, for example, (address mod N)=5 when the system is booted.

The generating of the random key pattern table does not have to be performed before the generating of the address pattern table. According to another exemplary embodiment of the present invention, the random key pattern table may be generated after the address pattern table is generated.

Referring back to FIG. 2, in operation 206, a mapping table is generated in order to map the random key patterns and the address patterns. The mapping table maps the random key patterns in the random key pattern table and the address patterns in the address pattern table so as to correspond to each other. The size of the mapping table may be determined to be the same as the sizes of the random key pattern table and the address pattern table, and may map the random key patterns and the address patterns so as to form a one-to-one correspondence with each other.

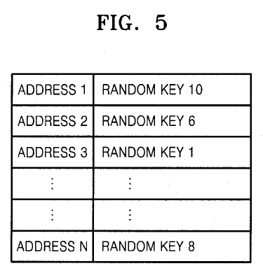

FIG. 5 is a diagram of an example of a mapping table according to the method of FIG. 2, according to an exemplary embodiment of the present invention.

Referring to FIG. 5, the mapping table maps N random key patterns and N address patterns so as to correspond to each other. For example, Address 2 corresponds to Random Key 6 and Address 3 corresponds to Random Key 1.

In order to prevent original data from being attacked by hackers, the mapping table may be updated whenever a system is booted. Also, in the mapping table, the random key patterns and the address patterns may be randomly mapped. For example, Address 1 does not always have to be mapped to Random Key 10 as shown in FIG. 5 and may be mapped to, for example, Random Key 5 when the system is booted.

According to another exemplary embodiment of the present invention, the random key pattern table and/or the address pattern table may be generated after the mapping table is generated.

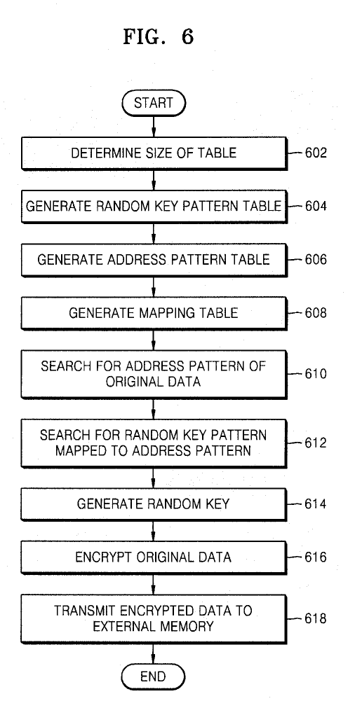

FIG. 6 is a flowchart of an encryption-based security protection method, according to another exemplary embodiment of the present invention.

Referring to FIG. 6, in operation 602, sizes of a random key pattern table and an address pattern table are determined. The sizes of the random key pattern table and the address pattern table may be the same. The size of a table may be properly controlled, for example, in consideration of an amount of storage space of an internal memory unit of a processor.

In operation 604, the random key pattern table is generated in order to allocate random key patterns of original data. The generated random key pattern table has the size determined in operation 602.

In operation 606, the address pattern table is generated in order to allocate address patterns of addresses to which the original data is stored. The generated address pattern table has the size determined in operation 602.

In operation 608, a mapping table is generated in order to map the random key patterns and the address patterns. Operations 604, 606, and 608 correspond to operations 202, 204, and 206 of FIG. 2 and thus detailed descriptions thereof will be omitted.

In operation 610, the address pattern of the original data to be transmitted to an external memory device is found from the address pattern table.

For example, it is assumed that the size of the address pattern table is N=3 and the address pattern table is as shown below by randomly arranging remainders obtained by dividing addresses by N.

Address Pattern Table

| | |
|---|---|
| Address 1 | 2 |
| Address 2 | 0 |
| Address 3 | 1 |

In this case, if a remainder obtained by dividing the address by N=3 is 1, the address pattern of the address is Address 3 according to the above address pattern table.

In operation 612, the random key pattern mapped to the address pattern is found using the mapping table and the random key pattern table.

For example, it is assumed that the random key pattern table and the mapping table each having the size of N=3 are as shown below.

Random Key Pattern Table

| | |
|---|---|
| Random Key 1 | 2^{nd} and 4^{th} bits |
| Random Key 2 | 1^{st} and 7^{th} bits |
| Random Key 3 | 3^{rd} and 8^{th} bits |

Mapping Table

| | |
|---|---|
| Address 1 | Random Key 2 |
| Address 2 | Random Key 3 |
| Address 3 | Random Key 1 |

In this case, Address 3 corresponds to Random Key 1 according to the above mapping table and the random key pattern of Random Key 1 is 2^{nd} and 4^{th} bits according to the above random key pattern table.

In operation 614, a random key of the original data is generated in accordance with the random key pattern. According to the above random key pattern table, the random key pattern is 2^{nd} and 4^{th} bits and thus the 2^{nd} and 4^{th} bits of the original data to be stored in the external memory device constitute the random key.

As a result, the same random key may not be used for original data of the same address and may vary in accordance with the original data that is to be recorded in the address. Accordingly, in effect, a hacker cannot possibly detect the random key generated according to an exemplary embodiment of the present invention. Furthermore, since the size of the random key pattern table or the address pattern table is determined when a system is booted, the storage space of the internal memory unit of the processor may be flexibly increased or decreased, thereby enabling efficient utilization of the storage space.

In operation 616, the original data is encrypted by using the random key. In this case, the bits of the random key of the original data are not encrypted and the other bits of the original data are encrypted. The random key is not encrypted because it has to be used again for decryption. (Refer to FIG. 9)

The original data may be encrypted by using, for example, an exclusive OR (XOR) operation. However, the encryption method is not limited thereto. A variety of encryption methods such as Advanced Encryption Standard (AES) encryption may be used.

In operation 618, the encrypted data is transmitted to the external memory device. Although the hacker accesses the encrypted data during the transmission, the original data may not be obtained from the encrypted data.

The encrypted data received from the external memory device may be decrypted by using the random key used when the original data was encrypted.

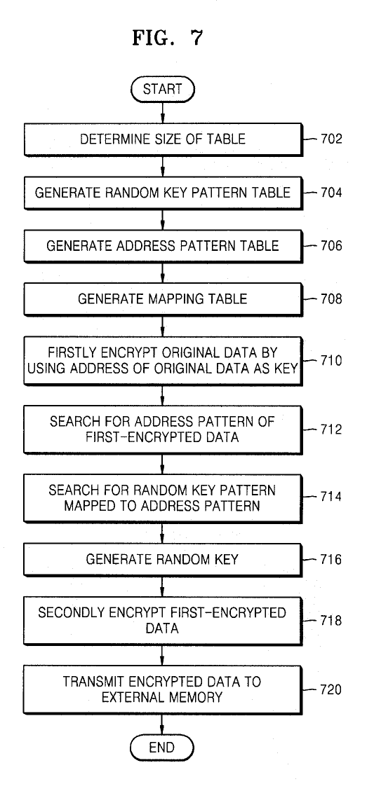

FIG. 7 is a flowchart of an encryption-based security protection method, according to another exemplary embodiment of the present invention;

Referring to FIG. 7, in operation 702, sizes of a random key pattern table and an address pattern table are determined.

In operation 704, the random key pattern table is generated in order to allocate random key patterns of original data.

In operation 706, the address pattern table is generated in order to allocate address patterns of addresses to which the original data is stored.

In operation 708, a mapping table is generated in order to map the random key patterns and the address patterns. Operations 702, 704, 706, and 708 correspond to operations 602, 604, 606, and 608 of FIG. 6 and thus detailed descriptions thereof will be omitted. Operations 704, 706, and 708 may be performed in any order.

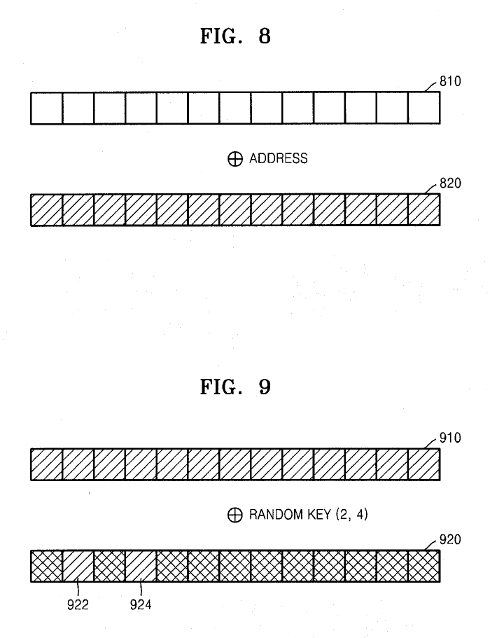

In operation 710, the original data is firstly encrypted (i.e., encrypted a first time) by using an address of the original data to be transmitted to an external memory device as a key instead of a random key in order to generate first-encrypted data. The original data may be encrypted by using, for example, an XOR operation. However, the encryption method is not limited thereto. FIG. 8 is a diagram of an example of encrypting original data 810 to intermediate data 820 by performing the XOR operation, according to an exemplary embodiment of the present invention.

Referring back to FIG. 7, in operation 712, the address pattern of the original data is found from the address pattern table.

In operation 714, the random key pattern mapped to the address pattern is found from the mapping table and the random key pattern table.

In operation 716, the random key of the original data is generated in accordance with the random key pattern. Operations 712 and 714 correspond to operations 610 and 612 of FIG. 6 and thus detailed descriptions thereof will be omitted.

In operation 718, the first-encrypted data is secondly encrypted (i.e., encrypted a second time) by using the random key to produce second-encrypted data. FIG. 9 is a diagram of an example of encrypting intermediate data 910 to second-encrypted data 920 by using a random key having a random key pattern of 2^{nd} and 4^{th} bits 922 and 924, according to an exemplary embodiment of the present invention. In this case, the 2^{nd} and 4^{th} bits 922 and 924 of the intermediate data 910, which are the random key, are not secondly encrypted because they are used again for decryption. As such, by firstly encrypting original data to the intermediate data 910 and then by secondly encrypting the intermediate data 910 to the second-encrypted data 920, the security of the original data may be improved.

Referring back to FIG. 7, in operation 720, the second-encrypted data is transmitted to the external memory device.

Encrypted data received from the external memory device may be decrypted by using the random key used when the original data was encrypted.

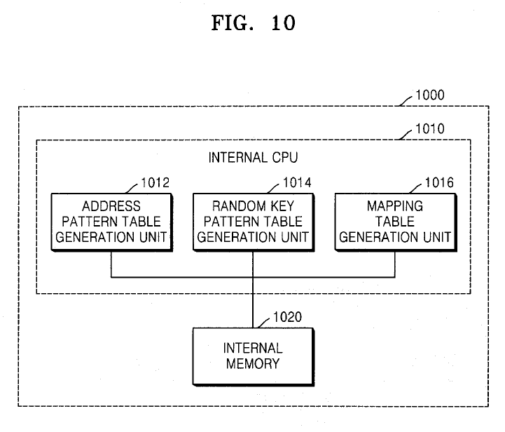

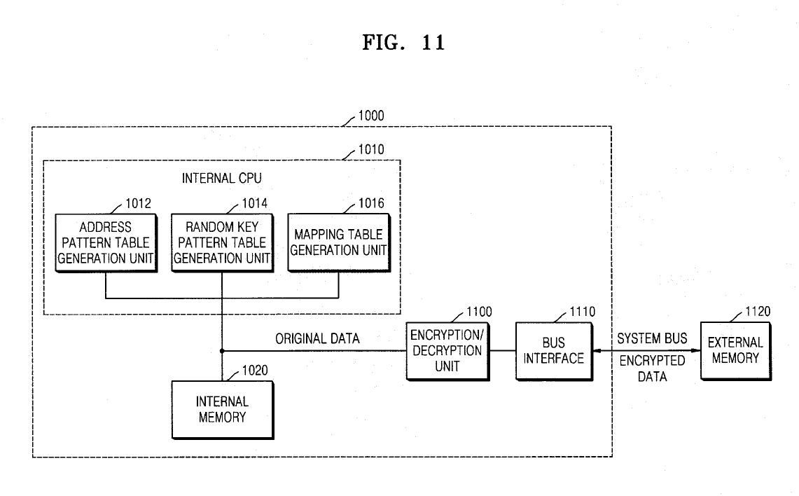

FIG. 10 is a diagram of an encryption-based security protection apparatus 1000, according to an exemplary embodiment of the present invention.

Referring to FIG. 10, the apparatus 1000 includes an address pattern table generation unit 1012, a random key pattern table generation unit 1014, a mapping table generation unit 1016, and an internal memory 1020. The address pattern table generation unit 1012, the random key pattern table generation unit 1014, and the mapping table generation unit 1016 may be included in an internal central processing unit (CPU) 1010.

The address pattern table generation unit 1012 generates an address pattern table in order to allocate address patterns of addresses to which original data is stored. The address pattern table generation unit 1012 may randomly allocate the address patterns. The address pattern table generation unit 1012 may randomly allocate the address patterns to remainders obtained by dividing addresses by the size of the address pattern table.

The random key pattern table generation unit 1014 generates a random key pattern table in order to allocate random key patterns of the original data. The random key pattern table generation unit 1014 may randomly generate the random key pattern table so that bits of a random key pattern have different bit positions or a different number of bits compared to bits of another random key pattern.

The mapping table generation unit 1016 generates a mapping table in order to map the random key patterns and the address patterns. The mapping table generation unit 1016 may randomly map the random key patterns and the address patterns.

The internal memory unit 1020 stores the address pattern table, the random key pattern table, and the mapping table respectively generated by the address pattern table generation unit 1012, the random key pattern table generation unit 1014, and the mapping table generation unit 1016. The sizes of the address pattern table, the random key pattern table, and the mapping table may be previously determined in accordance with internal storage space. Also, the sizes of the address pattern table, the random key pattern table, and the mapping table may be determined to be the same.

The address pattern table, the random key pattern table, and the mapping table may be updated whenever a system is booted.

FIG. 11 is a diagram of an encryption-based security protection apparatus 1000, according to another exemplary embodiment of the present invention.

Referring to FIG. 11, the apparatus 1000 includes an address pattern table generation unit 1012, a random key pattern table generation unit 1014, a mapping table generation unit 1016, an internal memory 1020, an encryption/decryption unit 1100, and a bus interface 1110. The address pattern table generation unit 1012, the random key pattern table generation unit 1014, the mapping table generation unit 1016, and the internal memory 1020 are described in FIG. 10 and thus a detailed description thereof will be omitted.

The encryption/decryption unit 1100 generates a random key in accordance with random key patterns obtained based on the address pattern table, the random key pattern table, and the mapping table respectively generated by the address pattern table generation unit 1012, the random key pattern table generation unit 1014, and the mapping table generation unit 1016. Also, the encryption/decryption unit 1100 encrypts original data or intermediate data by the random key.

According to an exemplary embodiment of the present invention, the encryption/decryption unit 1100 encrypts the original data by using an address to which the original data is stored. The original data may be encrypted by using one of a variety of encryption methods including an XOR operation. Then, the encryption/decryption unit 1100 searches for an address pattern of the encrypted original data, that is, the intermediate data and a random key pattern mapped to the address pattern. The encryption/decryption unit 1100 generates a random key of the intermediate data in accordance with the random key pattern and encrypts the intermediate data by using the random key.

According to another exemplary embodiment of the present invention, the encryption/decryption unit 1100 searches for an address pattern of the original data and a random key pattern mapped to the address pattern. The encryption/decryption unit 1100 generates a random key of the original data in accordance with the random key pattern and encrypts the original data by using the random key.

The bus interface 1110 transmits the encrypted data to an external memory device 1120.

The encryption/decryption unit 1100 may decrypt the encrypted data received from the external memory device by using the same random key.

The invention can also be embodied as computer readable codes on a computer readable recording medium. The computer readable recording medium denotes any data storage device that can store data which can be thereafter read by a computer system.

Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion.

As described above, according to exemplary embodiments of the present invention, by flexibly controlling the sizes of random key patterns and address patterns in accordance with storage space, the storage space may be efficiently used.

Also, by firstly encrypting original data using an address to which the original data is stored as a key and by secondly encrypting the first-encrypted data using a random key, security of the original data may be improved.

Also, by varying a random key in accordance with original data instead of using the same random key for original data of the same address, the random key may not be externally detected.

Furthermore, by updating random key patterns and address patterns whenever a system is booted, hackers may not detect the random key patterns mapped to the address patterns.

While the present invention has been particularly shown and described with reference to exemplary embodiment thereof, it will be understood by those of ordinary skill in the art that various changes in form and details may be made therein without departing from the spirit and scope of the invention as defined by the appended claims. The exemplary embodiments should be considered in a descriptive sense only and not for purposes of limitation. Therefore, the scope of the invention is defined not by the detailed description of the invention but by the appended claims, and all differences within the scope will be construed as being included in the present invention.

What is claimed is:

1. A method comprising:
generating a random key pattern table in order to allocate a plurality of random key patterns of original data to be transmitted;
generating an address pattern table in order to allocate a plurality of address patterns of addresses in which the original data is stored; and
generating a mapping table in order to map the plurality of random key patterns and the plurality of address patterns.

2. The method of claim 1, further comprising determining sizes of the random key pattern table and the address pattern table.

3. The method of claim 2, further comprising firstly encrypting the original data by using an address of the original data as a key to generate first-encrypted data.

4. The method of claim 3, further comprising:
searching the address pattern table for an address pattern of the first-encrypted data;
searching the mapping table and the random key pattern table for a random key pattern mapped to the address pattern of the first-encrypted data;
generating a random key in accordance with the random key pattern mapped to the address pattern of the first-encrypted data; and
secondly encrypting the first-encrypted data by using the random key to generate second-encrypted data.

5. The method of claim 1, further comprising:
searching the address pattern table for an address pattern of the original data;
searching the mapping table and the random key pattern table for a random key pattern mapped to the address pattern;
generating a random key in accordance with the random key pattern; and
encrypting the original data by using the random key.

6. The method of claim 2, wherein the random key pattern table and the address pattern table are generated so as to have the sizes determined by the determining of the sizes of the random key pattern table and the address pattern table.

7. The method of claim 2, wherein the method is newly performed whenever a system is booted.

8. The method of claim 1, wherein the plurality of address patterns of the addresses in which the original data is stored are randomly allocated.

9. The method of claim 1, wherein the plurality of random key patterns are generated so that bits of a random key pattern have different bit positions or a different number of bits compared to bits of another random key pattern.

10. The method of claim 1, wherein, in the mapping table, the random key patterns and the address patterns are randomly mapped.

11. The method of claim 2, wherein the generating of the address pattern table comprises allocating the plurality of address patterns to remainders obtained by dividing the addresses by the size of the address pattern table.

12. The method of claim 4, further comprising decrypting encrypted data received from an external memory device by using the random key.

13. An apparatus comprising:
an address pattern table generation unit which generates an address pattern table in order to allocate a plurality of address patterns of addresses in which original data is stored;
a random key pattern table generation unit which generates a random key pattern table in order to allocate a plurality of random key patterns of the original data;
a mapping table generation unit which generates a mapping table in order to map the plurality of address patterns and the plurality of random key patterns; and
an internal memory unit which stores the address pattern table, the random key pattern table, and the mapping table.

14. The apparatus of claim 13, wherein the address pattern table generation unit, the random key pattern table generation unit, and the mapping table generation unit respectively generate the address pattern table, the random key pattern table, and the mapping table according to previously determined sizes, respectively, of the address pattern table, the random key pattern table and the mapping table.

15. The apparatus of claim 14, further comprising a first encryption unit which firstly encrypts the original data by using an address in which the original data is stored as a key to generate first-encrypted data.

16. The apparatus of claim 15, wherein the first encryption unit searches for an address pattern of the first-encrypted data and a random key pattern mapped to the address pattern of the first-encrypted data, generates a random key in accordance with the random key pattern, and secondly encrypts the first-encrypted data by using the random key to generate second-encrypted data.

17. The apparatus of claim 13, further comprising a second encryption unit which searches for an address pattern of the original data and a random key pattern mapped to the address pattern of the original data, generates a random key in accordance with the random key pattern, and thirdly encrypts the original data by using the random key to generate third-encrypted data.

18. The apparatus of claim 13, wherein the apparatus newly generates the address pattern table, the random key pattern table, and the mapping table whenever a system is booted.

19. The apparatus of claim 13, wherein the address pattern table generation unit randomly allocates the plurality of address patterns of the addresses in which the original data is stored.

20. The apparatus of claim 13, wherein the random key pattern table generation unit randomly generates the random key pattern table so that bits of a random key pattern have different bit positions or a different number of bits compared to bits of another random key pattern.

21. The apparatus of claim 13, wherein the mapping table generation unit randomly maps the plurality of address patterns and the plurality of random key patterns.

22. The apparatus of claim 14, wherein the address pattern table generation unit allocates the address patterns to remainders obtained by dividing the addresses by the size of the address pattern table.

23. The apparatus of claim 16, further comprising a first bus interface which transmits the second-encrypted data to an external memory device.

24. The apparatus of claim 23, further comprising a decryption unit which decrypts encrypted data received from an external memory device by using the random key.

25. A computer-readable recording medium having a stored thereon a program for executing a method comprising:
generating a random key pattern table in order to allocate a plurality of random key patterns of original data to be transmitted;
generating an address pattern table in order to allocate a plurality of address patterns of addresses in which the original data is stored; and
generating a mapping table in order to map the plurality of random key patterns and the plurality of address patterns.
